(19) United States
(12) Patent Application Publication
(10) Pub. No.: US 2007/0161719 A1
(43) Pub. Date: Jul. 12, 2007

(54) Recycling cross-linked and/or immiscible polymers through shear mastication

(76) Inventor: James Thomas Rauh, Akron, OH (US)

Correspondence Address: JAMES T. RAUH, 420 KENMORE BLVD., AKRON, OH, 44301, US

(21) Appl. No.: 11/329,949

(22) Filed: Jan. 12, 2006

(51) Int. Cl. C08J 11/04

(52) U.S. Cl. 521/40

(57) ABSTRACT

The present invented process is a new and useful way of recycling commingled polymer scrap film, and may be used for further recycling applications. Using high-sheer mastication, this process is able to accomplish what thermoprocessing techniques could not and breaks down crosslinked and immiscible material. By adding a lower molecular weight polymer to the original scrap material under the right parameters, the material will intermingle with the new polymer which will inhibit it from reforming crosslinked molecular bonds. Furthermore, the addition of a lower molecular weight polymer allows for the resultant polymer to become thermoprocessable when processing temperatures are too high for the original material to melt. The invented process describes how to take polymer material previously sent to landfill and turn it into an easily reproccessable moldable polymer.

### CROSS-REFERENCE TO RELATED APPLICATIONS

U.S. Pat. No. 6,797,216 Furgiuele, et al. September, 2004
U.S. Pat. No. 6,479,003 Furgiuele, et al. November, 2002
U.S. Pat. No. 5,814,673 Khait, et al. January , 2001
U.S. Pat. No. 6,180,657 Khait, et al. September, 1998
U.S. Pat. No. 5,565,158 Sullivan, et al. October, 1996
U.S. Pat. No. 5,554,657 Brownscombe, et al. September, 1996
U.S. Pat. No. 5,415354 Shutov, et al. May, 1995
U.S. Pat. No. 5,397,065 Shutov, et al. March, 1995
U.S. Pat. No. 5,395,055 Shutov, et al. March, 1995
U.S. Pat. No. 4,636,340 Itaba, et al. January, 1987

### BACKGROUND OF THE INVENTION

1. Field of the Invention

This present invention relates generally to the field of processing and manufacture for the recycling of polymers. Moreover it pertains specifically to such a process for the reclaiming of scrap or off-grade cross-linked plastic film, single or multi-layer, with compatible or incompatible constituents, and reprocessing through twin-screw extrusion into an uncross-linked, homogenous, reusable polymer.

The world's annual consumption of plastic materials has increased from around 5 million tons in 1950 to nearly 100 million tons today. The rate of plastic consumption is increasing by 4% every year. The demand for plastic products is not decreasing despite the many studies showing that excessive plastic consumption and waste causes drastic environmental damage. The need for better and more efficient means of recycling plastics in evident in the rapidly growing landfills, the damage of chemical leaching into water and soil, the release of methane gas from anaerobic degradation, and the rapidly decreasing source of petrol for creating new plastics.

Post-consumer waste is typically where most studies regarding plastic consumption and methods of recycling are pertaining to, though industrial waste comprises a huge portion of landfill material. There are hundreds of millions of pounds per year of industrial waste plastic material in the field pertaining to the present invention alone. Post-industrial polymer waste requires more than 20% of landfill space. Post-consumer polymeric waste comprises approximately 20% by volume of the municipal waste stream. Regardless of industrial or post-consumer polymer waste distinctions, the biggest problem with plastic recycling in both sectors is commingled polymer constituents which make it too difficult or too energy in-efficient for recycling.

The major plastic companies contribute substantially to production of waste polymer material due to their production processes. Post-industrial waste can comprise polyolefins, PS, PET, and other polymeric materials used for plastic packaging. Commingled polymer film waste is not only damaging to the environment, it is also unprofitable and costs companies in production costs and disposal fees. The companies producing commingled plastics would be able to use the present invention to directly recycle a large portion of their waste plastic materials and increase their output while decreasing waste and having improved cost-efficiency.

Plastic packaging products represents the largest single sector of plastics use, accounting for 35% of plastics consumption and plastic is the material of choice in nearly half of all packaged goods. Plastic packaging materials are made of a wide variety of polymers. For example, according to Plastics Compounding, November/December, 1992 the following polymers were used in packaging material: 27% LDPE, 21% HDPE, 16% PS, 16% PP, and 5% PET. Since then, there has been increased use of PVC in plastic packaging materials, which has made recycling plastics even more difficult. The largest type of plastic packaging product is commingled film, nearly all of which currently ends in landfill.

Attempts to recycle plastics have been mostly unsuccessful in truly solving the problems involved in over-consumption of plastic products. Currently, collection of plastic waste material exceeds the market demand for recycled plastic products as a result of the lack of viable recycling technologies that are low cost and produce quality plastic products. Recycling approaches of grinding, melt processing, and pellitizing of commingled, unsorted plastic waste requires a great deal of energy but produces plastic with poor physical properties and inferior appearance. Melt processing recycling of commingled polymer scrap may cause thermal degradation, yielding chlorine gas or dioxin, therefore it is not an often utilized process.

Other difficulties with recycling plastics include how certain melt processing techniques, such as blow molding, rotational molding, extrusion, and spray coating, require a plastic powder feedstock. Scrap flake material is not processable until it is ground, pellitized, then ground to powder form before it can be melt processed, all of which adds to the cost and complexity of recycling scrap plastics as well as the capital equipment expenditures required. Even if the scrap plastic flake can be pellitized for injection molding, the resultant molded part would suffer from the deficiencies in properties and appearance of polymer incompatibility.

Furthermore, when pigments or chemical additives are used to improve color uniformity or mechanical strength, for example, the cost is increased considerably, making the product less desirable than most virgin or prime material plastics. So-called compatibilizing agents and/or reinforcing agents can be added to flake plastic scrap material comprising chemically incompatible polymers in attempts to produce a recycled plastic product exhibiting more desirable characteristics. However, addition of these agents to the plastic scrap material makes recycling more difficult and adds to the cost, as well as creating more damage to the environment when these chemicals leach from landfill into the soil and water.

The present invention pertains generally to the field of plastics recycling and addresses the issues aforementioned. The process described herein can be applied to a broad range of plastics through the variation of aspects of the technique presented. However, the present invention is immediately and particularly applicable to the field of reclaiming cross-linked and/or immiscible polymer film. There has been no prior success in reclaiming such material because of the inability to melt process this material due to its chemical structure and intimately commingled constituents.

Many types of polymer film used for packaging products are made using combinations of polyethylene-based materials combined with a variety of polymers. HDPE, LDPE, LLDPE, EVA, PVDC, PP, COPE, Nylon, are just a few of the ingredients often commingled to create the proper physical properties required of packaging products. When the film is made, it can be single or multi-layered with compatible or incompatible constituents. To make shrink film, the material is oriented, stretched, and can be subjected to electron-bombardment. This causes the polymer molecules to form cross-linked, crystalline, or orientation bonds so that the material can be used for applications such as shrink-wrapping for packaging material.

Due to this process, the polymer material gains molecular weight rapidly and becomes intimately commingled such that it can no longer be a thermoplastic. When industries produce this form of plastic product, they also produce hundreds of thousands of pounds of scrap immiscible material that is unsuitable for the market. This currently goes directly to landfill because it cannot be melt processed and/or because the cross-linked molecular bonds cannot be unbound, keeping the polymer material in a completely unusable and non-biodegradable state.

Post-consumer waste of this material further increases the negative impact of producing cross-linked or immiscible polymer blends, particularly because it can become commingled further with other types of incompatible plastic scrap. This material cannot typically be mixed together into scrap flake and thermoformed because it has such high melting point and molecular weight. This present invention creates a closed-circle recycling process that could circumnavigate some of the problems involved in post-consumer scrap plastic reuse. Given improvements in sorting procedures, 100% of scrap cross-linked or immiscible polymer film could be continuously recycled into the same application, rescuing many hundreds of millions of pounds per year from landfill.

Previous attempts to recycle polymer blends including polyethylene have shown that even when sorted and separated, plastics of different viscosities are incompatible. However, there is no delayed phase inversion when the polymer materials have the same viscosities. When the scrap polymer material has been subjected to processing, its viscosity is much higher than polymers that are of the same type but have lower molecular weight, therefore, even when all constituents are seemingly compatible, the polymer film has been unsuccessful at being reclaimed.

Most plastic recycling does not mean a closed circle cycle, but rather an energy reclamation process wherein scrap polymer materials are used for new applications. Rather than being reprocessed for the polymer's original use, the scrap is used for less demanding product applications, such as plastic lumber or polar fleece jackets as opposed to packaging material or products requiring good physical properties. Because packaging material must be “clean” and containing no contaminants, there is presently virtually no recycled plastics being used for these applications. Virgin resources must continuously be tapped to create polymer mixtures of plastic packaging material to fill market demand. The present invention provides a process in which the same polymer material as the primary application can be reused as a clean polymer with equal physical properties therefore eliminating much of the need for producing prime material.

### BRIEF SUMMARY OF THE INVENTION

A method of recycling immiscible and/or cross-linked scrap polymeric material using shear mastication by combining said material with an uncross-linked, lower molecular weight polymer. This is accomplished, after separating the reclaimed plastic by type, by using high-shear rubber or plastics compounding equipment. The present preferred equipment for this process is a twin-screw extruder. The proper parameters are required, such as heat, duration, and screw element arrangement. The scrap polymer material, which is typically but not limited to the form of film, is ground or masticated then fed into the extruder, where it is subjected to very high shear due to the mechanical force of the rotating twin-screw elements. The polymer material undergoes a rubbery phase within the extruder at which time a lower-molecular weight polymeric material is introduced. This uncross-linked polymer is fed into the extruder at the proper time and position, and combines with the primary scrap material, forming a homogenous dispersion. The strong molecular bonds of the scrap polymer are broken and the resulting material is extruded and pellitized. The resulting polymer can now be melted, molded and made into applicable products. This material is now processable and reusable as any formable plastic.

### BRIEF DESCRIPTION OF THE DRAWINGS

The following drawings further describe by illustration the advantages and objects of the present invention. Each drawing is referenced by corresponding figure reference characters within the “DETAILED DESCRIPTION OF THE INVENTION” section to follow.

FIG. 1. is a basic representation of a side dissected view of the feed and twin-screw element of the extruder and the function of the screws to mix the polymers according to the present invention.

FIG. 2. is a basic representation of a front dissected view of the co-rotating twin-screw element of the extruder according to the present invention.

FIG. 3. is a basic representation of the function of the intermeshing screws of a twin-screw extruder.

FIG. 4. is a basic representation of the construction of matter and the changes that take place therein according to the present invention.

FIG. 5. is a basic representation of molecular structure of the involved polymers before and during the mixing process.

FIG. 6. is a general representation of a side view of a twin-screw extruder and Gala system and the stages of production according to the present invention.

FIG. 7. is a representation of a possible screw element configuration used for extrusion.

### DETAILED DESCRIPTION OF THE INVENTION

Accordingly several advantages and objects of the present invention are:

A principal object of the present invention is to provide a process of recycling cross-linked and immiscible polymers that will overcome the deficiencies of the prior art processes of recycling plastics.

An object of the present invention is to provide a method of recycling cross-linked and immiscible polymers that allows an alternative to wasting any such polymer, particularly plastic film.

Another object of the present invention is to provide a method of making cross-linked film into a thermoformable plastic, thus salvaging scrap cross-linked film from going to landfills due to its prior non-processability.

Another object of the present invention is to provide a process in which cross-linked and/or immiscible polymers can be manipulated to yield a plastic that can be reused over and over again, saving vast amounts of waste materials, money, and resources.

Another object of the present invention is to provide a method of breaking down of the strong bonds of a cross-linked or heavily bonded, high molecular weight material through high sheer and the proper combinations of matter, providing advancement in polymer engineering applicable to many areas of the plastics industry.

Another object of the present invention is to provide an efficient technique of mixing a cross-linked polymer and an uncross-linked polymer into a homogenous dispersion, eliminating prior difficulties of an unevenly dispersed mixture.

Another object of the present invention is to provide a set of parameters that allow a twin-screw extruder to sufficiently break down the long-chain polymer, allowing for the possibility of introducing new materials and resulting in different chemical compositions.

Another object of the present invention is to provide an answer to the previous problems facing the plastic film industry, as well as other industries involved in the use of cross-linked and immiscible polymers, such that huge quantities of such polymers can become efficiently manipulated into an uncross-linked polymer, similar is composition and application to the original material before it underwent the process of becoming cross-linked.

Another object of the present invention is to provide a conceptual basis for further development in the field of plastics recycling through the discovery of a method of mixing a plastic of lower molecular weight to one of high molecular weight to yield a polymer containing properties of both.

Another object of the present invention is to provide a process of recycling cross-linked polymer film into a polymer that can be reused by the same market that created the scrap, thus allowing for in house reuse of resources, as well as the extension of this technique into many areas of consumer byproduct recycling. The overall result is the prevention of many millions of pounds of material, previously considered waste, from entering landfills, thus helping to alleviate some of today's problems of waste management.

Another object of the present invention is to create the first viable high quality recycled plastic from a cross-linked or immiscible constituent that can be used in the production of millions of pounds of plastic film or other formable plastics that have many useful product applications, thus providing an alternative to the manufacture of more of such polymers used to make cross-linked polymer film, as well as the potential for other prime market polymer replacement. This would help to alleviate some of today's problems of environmental damage due to the harvesting of petrol and some of the harmful procedures in plastics manufacturing.

The process of this invention provides a simple reclamation process using common industry machinery and low cost production to transform a material previously completely unusable into a perfectly homogenous prime grade plastic material that can be easily reprocessed into film or molded into other form.

The process of this invention includes manipulating a non-thermoformable immiscible polymer using rubber technology into a less viscous, more pliable rubbery polymer mixture, allowing it to relax its chemical bonds enough to make new molecular bonds with another polymer, and doing so without excessive energy consumption.

The process of this invention uses an inexpensive range of low molecular weight polymers, typically polymers considered waxes, combined in just the right way with the scrap material so as to achieve homogenous dispersion and create a product of high quality and immediate demand.

The basic purpose of the present invention is to provide a process of recycling cross-linked and immiscible polymers that is more universally functional in today's market than the prior art processes. It is intended that any other advantages and objects of the present invention that become apparent or obvious from the detailed description or illustrations contained herein are within the scope of the present invention.

Referring now descriptively to the drawings, the attached figures illustrate the invented process of recycling cross-linked or immiscible polymer material. FIGS. 1-7 illustrate a process of recycling cross-linked or immiscible polymer material according to the present invention, through twin-screw extrusion wherein the immiscible material is able to become reprocessable.

A new method for recycling cross-linked and immiscible or incompatible polymers is presented in the following description, not limited to but including the following specifications. Polymer film, which is cross-linked or strongly molecularly bonded, scrap or off-grade, single or multi-layer, with compatible or incompatible constituents, is reclaimed and made available for recycle. Such film is separated by type depending upon its constituents, presently into four groups, but not limited to these four compositions of polymer film. The materials currently used in this process are all too tightly bonded on the molecular level, with such high molecular weight, the polymers are unable to melt, under conditions applicable to the plastics processing industry. The problem of previous attempts to recycle such material is that the constituents are either cross-linked or simply need too high of a temperature to be processed and so are immiscible.

The scrap polymer film material will be hereafter referred to as Polymer A and the second polymer material of lower molecular weight will be hereafter referred to as Polymer B. The invented process currently uses six types of commingled polymer blends as Polymer A. All six current polymer blends used are scrap film consisting of LLDPE combined with other polymers, such as co-polyester, PP, EVA, PVDC, and Nylon, at different percent compositions. The process is not limited to these six types, but does include them, and the basic chemical compositions can vary in percentages and may include additives, however are similar to these.

Polymer A:

| | |
|---|---|
| Type M (1): | COPE - 30% |
| | LLDPE - 50% |
| | PP - 20% |
| Type F5 (2): | EVA - 15% |
| | LLDPE - 75% |
| | Nylon - 10% |
| Type F8 (3): | EVA - 50% |
| | LLDPE - 50% |
| Type B (4): | EVA - 25% |
| | LLDPE - 60% |
| | PVDC - 15% |
| Type ML (5): | EVA - 30% |
| | LLDPE - 50% |
| | PVDC - 20% |
| Type BOPP (6): | PP - 90% |
| | PVDC - 10% |

All of the types of Polymer A presently used have in common the fact that they are all immiscible and have a melt flow index value of zero, meaning they cannot be melt processed. In types 1, 2, and 3, the material contains crosslinked molecular bonds that render the material immiscible, whereas in types 4 and 5, the material contains a barrier layer of PVDC, therefore the melt index is above the degradation temperature of PVDC, rendering it immiscible. With type 6, the material has undergone bi-actual orientation during thermoforming processes, forming long crystalline chains that do not break down at melt processing temperatures, rendering it immiscible. All of these types are currently non-recyclable by any method other than the present invented process.

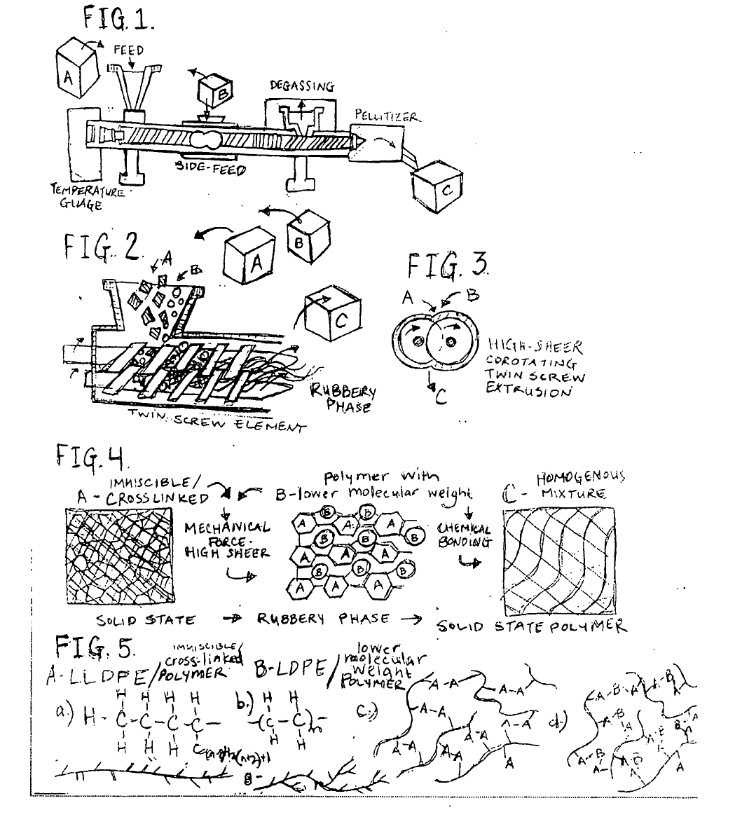

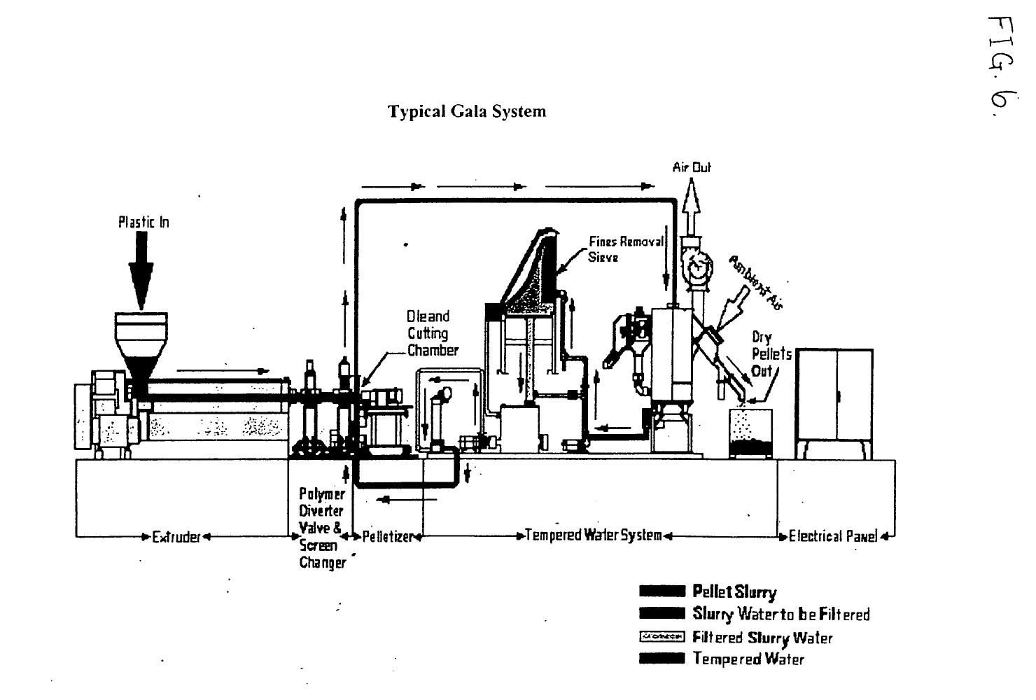

The basic construction of matter of Polymer A is represented in FIG. 4 and the basic molecular structure of Polymer A is represented in FIG. 5, in both figures Polymer A is designated by the letter A. Polymer A is ground or masticated into a substrate consisting of smaller, extrusion feedable sized particulates. This process of grinding may be done any time prior to the extrusion process and may be done using a standard grinder. Polymer A is provided for extrusion typically in flake form which may or may not need densification depending upon the equipment and parameters of the extrusion process. The most efficient technique thus found for extrusion utilizes a crammer feeder system, yielding higher rates for large extruder systems.

The polymer of lower molecular weight, hereafter referred to as Polymer B and designated by B in the drawings, can be a wide variety of polymers, from either a prime source or as non-contaminated scrap. The current materials used consist mostly of other polyolefins, such as LDPE or LLDPE, but include TPU, Nylon, co-polyester, vinyl, and EVA. The most efficient polymer found as yet for this process is a wax of low molecular weight polyethylene derived from HDPE, however, other waxes derived from polypropylene or other polymers have also been used effectively. The molecular weight of the preferred wax used is in the order of 1000 to 1200 Mn and possesses extremely low melt viscosity ranging from <10<60 mPas at 149 degrees Celsius. It has a narrow molecular weight distribution falling between values of 1.2 to 1.5 and contains no additives. In combination with this wax, an addition of non-crosslinked LLDPE has been found to improve homogenous dispersions and/or production rates in some trials. The Polymer B mixture can be a wide variety of polymers requiring primarily less molecular bonding, no cross-linking, and thus lower molecular weight.

The composition and percentage needed of Polymer B depends on the compositions of Polymer A. The M material (type 1) has shown excellent processing and physical properties when combined with percentages varying around 30% of materials such as TPU, LDPE, PE wax, and/or other additives as Polymer B. The F5 material (type 2) has had excellent results with percentages varying around 23% of PE wax material as Polymer B, however, other materials and additives have been used successfully. The F8 material (type 3) has shown great results with percentages between 15% and 25% of PE wax with or without around 25% LLDPE serving as Polymer B. The B material (type 4) has shown preferred production rates with a combination of PE wax and LLDPE at percentages between 15% and 25% each. Materials ML (type 5) and BOPP (type 6) may have a wide range of percentage loading and materials acting as Polymer B, with the same basic parameters as aforementioned, and may or may not utilize additives such as stabilizers to improve production. All of the specifications aforementioned are only examples of possible compositions and percent loading of Polymer B and may be altered and still fit within the scope of the present invention.

The high shear extrusion process described in the present invention may be carried out by a banbury, a mill, an extruder, or any other high shear rubber or plastics compounding machinery. When using an extruder, the process can be carried out by a system containing any standard industry twin-screw extruder, with or without different crammer or feeder components, with or without a Gala underwater system, and including a pellitizer. A typical system employed in the current invented process is represented in FIG. 6, but is not limited to this specific arrangement. This extrusion machine is a high shear, co-rotating or counter-rotating, twin-screw extruder equipped with the proper screw element arrangement, one having two opposing screws in very close contact.

In order for the invented process to be immediately applicable to industry standards, there must be a reasonable high production rate. A minimum of 1,000 pounds per hour must be produced. These rates have been exceeded in trials with results over 1,000 pounds per hour, and may continue to improve with further adjustments. Sufficient RPM is required to yield a desirable rate of production, varying in the range of 100-1200 RPMs. A crammer feeder is suggested in order to more efficiently process the material. A belt feeder may or may not be used to feed the flake material into the crammer.

When utilizing a twin-screw extruder as the method of compounding, production rates have exceeded expectations and shown ease of processing that make the present invention immediately viable for industry application. For standard compounding in non-heat sensitive systems, lab test results have provided possible rates and horsepower values for a full industrial sized twin-screw extruder. A lab extruder with a 58 mm Motor has shown a max speed of 1150 RPM and run speed of 1100 RPM with a 600 horsepower, a % load of 52%, a throughput of 1733 pph, and a specific energy value of 0.1722 HP/pph. The scale up values for a 104 mm extruder shows a max speed desired of 600 RPM with required HP of 938, recommended HP at 85% load of 1104, a guaranteed rate maximum speed of 871 RPM and max expected throughput of 9991 pph. The values aforementioned represent only one manifestation of the present invention, however values will vary based on equipment, materials and load compositions, as well as other factors, and may improve with further trials.

Polymers A and B are fed into the main feed of a twin-screw extruder, though Polymer B may also be added further down the line from a side feed, as shown in FIG. 1. When the preferred method of adding Polymer B at a side feed is applied, Polymer A has become warmed and rubbery from sheer mastication when the cold, fluid wax or other polymer material is added. The extrusion barrel is set for time, temperature, sheer, and pressure in this process to degrees varying depending on the compositions of the materials, temperatures between 30 degrees Celsius to 300 degrees Celsius and duration of approximately 30 seconds to 5 minutes at minus 150 PSI to 3000 PSI. A Gala system may be incorporated to improve production, the temperatures of which are set according to the material type.

The screw element configuration is an important factor to the present invented process and has been designed to apply the proper shear at the proper time to result in a high production rate. The screw elements can be adjusted and altered to match the specific needs of each of the types of Polymer A, allowing the twin-screws to be spinning at the proper speed with the proper shaft length to result in the most efficient method of breaking down the long-chain molecular bonds of Polymer A. FIG. 2 shows a representation of the effect of the twin-screw element upon Polymers A and B and the result of this high sheer to achieve a more viscous, rubbery phase material.

FIG. 3 shows a possible representation of the motion of the rotating twin-screws and the overlay of the screw element, allowing only small portions of the polymers to pass, causing rapid incisions that break down Polymer A while also allowing Polymer B into the mixture. Such that when the proper temperature and duration of extrusion are set, the materials pass through the length of the screw element and allow for the recycling process to occur. The force and speed of the extruder along with the extremely close contact of the intermeshing flights of the twin screws causes Polymer A to begin breaking down into small enough polymer blocks to enter a less rigid rubbery phase, allowing for processability that heat application could not achieve.

The different sections of the extrusion barrel are configured to maintain the proper heat, high enough to keep the material flowing, low enough to prevent degradation of the product. The length vs. diameter of the extruder and the RPM of the extruder are important factors in this. The screw element configuration must also be such that the material goes through sections of mixing, followed by relaxing, followed by mixing, so that the materials may become matched and lose their individual molecular weights, adopting an average of the two. Each mixing section allows for greater and greater shear, lower in the beginning to avoid burn up of the product, and higher near the end to ensure homogenous mixing.

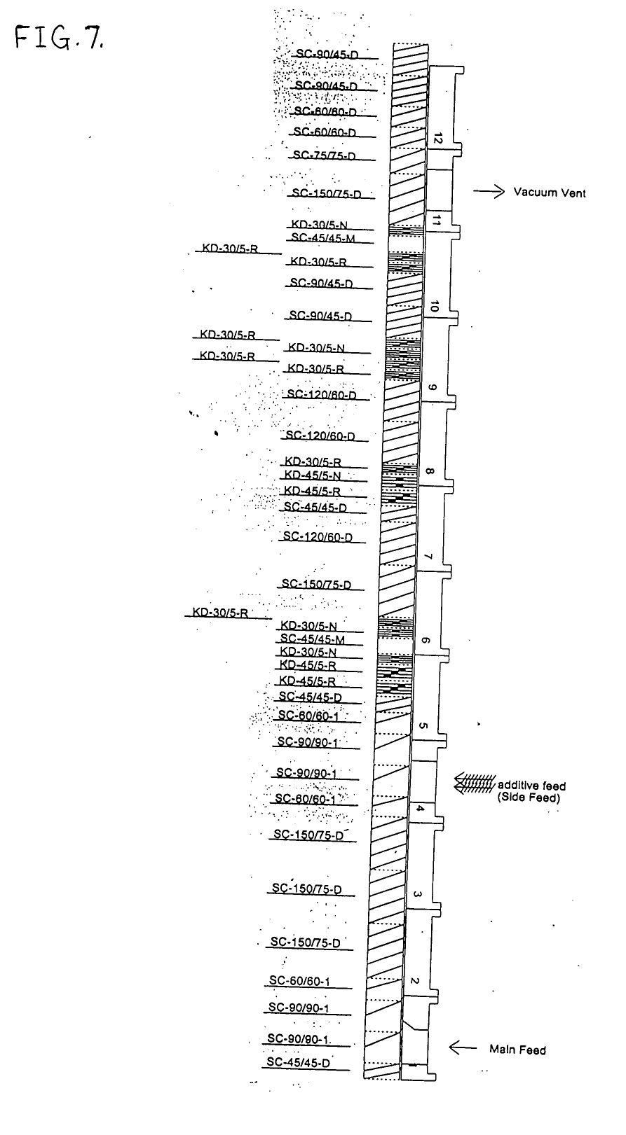

One example of a possible screw element configuration is represented by FIG. 7 and is the design used in the present application of this invented process. Variations may be applied to this design and still be contained in the scope of the present invention. FIG. 7 shows a screw element configuration for a 58 mm Extruder with 12 segments, each having different components. Where the lines are closer together, this denotes smaller screw components creating areas of higher shear. The areas of highest shear occur after both Polymer A and Polymer B have been added to the extruder and the mixture is undergoing a rubbery phase transition, and also just before the mixture is subjected to a vacuum. The screw element configuration may be the same for all four types of Polymer A materials or it may be altered to better suit the specific components. Polymer A, type 2, contains PVDC and thus degrades at temperatures above 350 degrees Fahrenheit. Therefore, it may be necessary to install a screw tip cooling apparatus onto the screw element to gain temperature control.

Referring now to FIG. 6, a preferred method of extrusion and pellitization of Polymer C is shown utilizing a Gala water system. Variations to this system can be used and still be covered in the scope of the present invention. The mixture of Polymer A and Polymer B, hereafter referred to as Polymer C and designated by C in the drawings, begins to form within the twin-screw extruder. After Polymer C has formed, the material is subjected to a vacuum causing any contaminants to exit the mixture as well as evaporation before it is pushed out of the barrel and into the next section of the Gala system. The Polymer diverter valve and screen changer allows for the material to be directed to the pellitizer or to be purged out on the ground. When the material is diverted through a screen at the barrel face, this forces the material into strands. The barrel face is directly pressed against a cold water system, which quickly cools the polymer material.

The die and cutting chamber is the next step in the process and houses the blades. These spin rapidly against the cooled strands, cutting the strands into droplet-sized segments of material. These segments are in effect flash-frozen by the cool water into solid pellets with smooth surface and are immersed in the water. The pellet and water mixture, called pellet slurry, is forced under pressure towards the airshaft. Here, the water is separated from the pellets along a series of ramps where the water is drained out through sieves built into the wall of the airshaft. The pellets are pushed up using air pressure and then subjected to ambient air allowing for dry pellets to exit out. The water is then recycled through a fines removal sieve, filtering the water. The cleaned water goes back through the tempered water system and into the pellitizer to complete its cycle. The electrical panel is also depicted in FIG. 6. This houses the controls that dictate temperature, speed, and duration and monitors the extrusion process.

FIG. 4 shows a representation of the change from Polymer A to Polymer C, a homogenous and miscible polymer. Although the properties of both Polymers A and B will be incorporated into the resultant properties of Polymer C, there are no longer any cross-linked bonds or non-compatible constituents. The entire mixture will take on the properties wherein the resulting material remains at a lower molecular weight and is stable and strong, yet not so tightly bound that it cannot melt and it becomes soluble. Test results of the material produced from the present invented process show remarkable physical properties. The values of some test results indicate that as more of Polymer B is added to the composition, the melt flow index values increase and tensile strength decreases. The melt index of one version of the process using the BOPP material is 7.6 g/10 min. with tensile strength of 3475 Psi and elongation of 30%. By adding more wax, the melt index increased to 10.7, the tensile decreased to 2425 Psi with elongation of 24%. Some other materials have not exhibited this trend, however. Some test results showing Melt Flow index and tensile strength and elongation are exhibited in the following table.

| | TABLE1 | | | | | | | |
|---|---|---|---|---|---|---|---|---|
| | Material | | | | | | | |
| | M-a | M-b | F5 | F8 | B-d | B-h | ML | BOPP |
| MFI | 7.12 @ | 8.15 @ | 7.6 @ | 9.4 @ | 6.94 @ | 7.4 @ | 2.2 @ | 10.7 @ |
| g/10 min. | 300° C./ | 300° C./ | 260° C./ | 300° C./ | 150° C./ | 150° C./ | 170° C./ | 170° C./ |
| | 3.8 Kg | 3.8 Kg | 2.16 Kg | 3.8 Kg | 8.6 Kg | 8.6 Kg | 2.16 Kg | 2.16 Kg |
| Tensile | 1979 | 2215 | 2221 | 2084 | 1849 | 1813 | 2875 | 2425 |
| strength | | | | | | | | |
| Psi | | | | | | | | |
| elongation | 549% | 698% | 780% | 530% | 176% | 177% | 887% | 24% |

These values represent only one manifestation of the present invention. Other values have been reached by varying the compositions and percent loads of the Polymer B material and/or by changing parameters of the extrusion process. Any other values for the tests aforementioned are included within the scope of the present invention. Depending on the specifications required of the material for thermo-processing, melt index, tensile strength, or elongation values may be adjusted to better suit specifications, however the above listed values show that the material is suitable for blow molding, extrusion, injection molding, or other standard industry thermo-processing.

The finished pellets of Polymer C are miscible and can be used for processing into film or molded parts. This result occurs because of the even dispersion of Polymers A and B due to the chemical and mechanical changes during the extrusion process. The chemical process that takes place within the extruder is due to the natural affinity of atoms to form bonds that result in a more stable electron configuration and to exist at the lowest potential energy possible. When atoms do not have a full outer valence level, they tend to form molecular bonds with other atoms they contact in order to become more stable. Polymer A is fully bonded, it has no available valence or ability to make molecular bonds with introduced chemicals.

FIG. 5 shows a representation of the difference in chemical structure between Polymer A and Polymer B, using LLDPE as an example of one of the constituents of Polymer A and LDPE as one of the constituents of polymer B. LLDPE is a longer chain molecule with more carbon-carbon bonds and when mixed with the proper polymers and put through, in this case, an electron beam, the molecules will become cross-linked. This reaction leads to the formation of insoluble and infusible polymers in which chains are joined together to form a three-dimensional network structure. The functional groups in the polymer, designated as A in FIG. 5, react among themselves to form chemical bonds A-A. In Types 1, 3, and 4 of the scrap polymer film being used as Polymer A, all the functional groups react to be tied to each other in A-A bonds, forming, in principal, one giant molecule. In the case of Type 2 of polymer A, where there is no cross-linking, it still contains long chain molecules with extremely strong chemical bonds.

Due to the extremely stable formation of Polymer A, either the cross-linkage in Types 1, 3, and 4, or as in Type 2, the highly structured but uncross-linked bonds, the polymer is immiscible. The material of Polymer A requires extremely high heat to excite the atoms enough to melt. The heat required for this to take place is beyond the oxidation degradation burning point of the polymers, thus rendering the material non-processable through normal techniques. Therefore, a new technique is required to process this material and salvage it from landfill. The present invented process utilizes rubber technology and presents a way of breaking down the immiscible polymer using mechanical force rather than thermal energy with very high shear extrusion.

The mechanical force of the twin-screw extruder is necessary to “cut” or sheer the long-chained molecules of Polymer A into small enough molecule blocks to break the chemical bonds. The conjugated blocks of the cross-linked or heavily bound molecular components of Polymer A are broken, opening chemical bonding potential and rapidly decreasing density and molecular weight. The freed functional groups of Polymer A create a now available electron valence and a potential for molecular bonding to occur between chemicals. In order to keep Polymer A from simply returning to its cross-linked or immiscible state after it has been sheered down, it must combine with an uncross-linked polymer or other plasticizers at high enough loads to create a homogenous dispersion.

The addition of a polymer of lower molecular weight after the bonds have been severed through the mechanical force of the high sheer twin screw extruder causes a reaction that bonds the functional groups of Polymer B, designated in FIG. 5 by B, to the functional groups of Polymer A. When Polymer B becomes evenly mixed throughout the polymer matrix, the chemical constituents of polymer A are not free to bond with each other and become recrosslinked. Because of its lower molecular weight, Polymer B has a natural tendency to disperse, filling up the available valence of the functional groups from Polymer A. Polymer A will bond with Polymer B because there is more available valence for chemical bonds to take place along the functional groups of Polymer B and a lower energy coefficient increasing the potential for this reaction. The result is Polymer C, a homogenous mixture free of cross-links.

Polymer A is insoluble, immiscible, incompatible, or somehow unprocessable because of its tightly bound molecular structure or thermal stability at process temperatures. This means that once formed, such as made into film as is the current form of Polymer A, it cannot be melted and reused, it must be scrapped and sent to a landfill. There is no efficient method for recycle prior to this invention, but the method of using high sheer as opposed to extremely high heat to break down the molecule, while combining it with a polymer of lower molecular weight circumnavigates these problems and allows for the material to become miscible and reusable. Because there is no longer any thermal degradation at process temperatures or long-chain strong molecular bonds, the result is a miscible, soluble, meltable, processable, recyclable polymer.

It is intended that the detailed description is sufficient in expressing the physical and: chemical steps involved in the present invented process. The materials, machinery, and parameters of extrusion have been specified in enough detail to allow for reproduction of this process using the information herein. It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

We claim:

1. A process of recycling scrap polymeric material, comprising the steps of:
providing scrap polymeric feedstock comprising of polymer materials that have crosslinking in their molecular structure and/or are thermodynamically immiscible;
applying mechanical energy to the polymeric feedstock through shear mastication into rubbery phase, thus lowering the viscosity of the first polymer material;
Combining the first polymer material with a lower molecular weight polymer of low viscosity, allowing for intimate mixing of the first and second polymer materials to form a homogenous mixture; and
Making a product from the uncross-linked, homogenous particulate mixture, said product being microstructurally stable.

2. The process of claim 1, wherein the first and second polymer materials are of the same type as one another.

3. The process of claim 1, wherein each the first and second polymer materials constitute different polymer materials from one another.

4. The process of claim 1, wherein the first of the polymer materials includes at least two polymer constituents.

5. The process of claim 1, wherein the first of the polymer materials includes polymer constituents from the group consisting of poly-ethylene materials, polyesters, polystyrenes, polyacetals, vinyls, polypropylene materials and combinations thereof.

6. The process of claim 1, wherein the first polymer material contains some strong molecular bonds in its chemical structure, those being either cross-linked or strong enough to make the polymer immiscible.

7. The process of claim 1, wherein the first polymer material is currently provided as scrap or off-grade plastic film, single or multi-layer with compatible or incompatible constituents.

8. The process of claim 1, wherein the first polymer material is considered waste due to its molecular structure, which inhibits thermoforming and reprocessing.

9. The process of claim 1, wherein the first of the polymer materials is ground from film or other form into extruder-feedable sized particulates.

10. The process of claim 1, wherein the second material is provided as any polymer mixture of a lower molecular weight than the first polymer material but more specifically those polymers which are considered waxes.

11. The process of claim 1, wherein the first and second polymer materials are incompatible by way of melt processing.

12. The process of claim 1, wherein said step of applying mechanical energy consists of high-sheer mastication and further comprises of the breaking down of the cross-linked molecular bonds of the first polymer material.

13. The process of claim 14, wherein the application of high-shear with the proper temperature allows the first polymer material to enter a rubbery phase of lowered viscosity.

14. The process of claim 1, wherein the introduction of the second polymer material at the proper time and placement causes an intermingling of the polymer constituents, imparting upon the first polymer material certain properties of the second.

15. The process of claim 1, wherein:
The first polymer material has a high viscosity and molecular weight and may contain cross-linking and it cannot effectively be subjected to thermo-processing or blow molding,
The second polymer material has a second viscosity, which is lower than the first viscosity; and
Said making a product comprises combining the first and second polymer materials when the first has a somewhat lowered viscosity during processing;
Said step of applying mechanical energy allows shear mastication to break down the long chain molecules of the first polymer and intermesh the polymer having short molecule blocks.
Mixing the first and second polymer materials produces a material with a viscosity which is lower than the first polymer material; and
Said process results in a material with a proper viscosity for all plastic processes including blow molding, injection molding, extrusion, profiles, and thermoforming.

16. The process of claim 1, wherein said mechanical energy is applied by a high shear rubber or plastic compounding machinery such as a banbury, a mill, or a twin-screw extruder.

17. The process of claim 20, wherein when mechanical energy is supplied using a twin-screw extruder, said extruder has side-by-side, intermeshing co-rotating or counter-rotating screws.

18. The process of claim 21 wherein said extruder is set with the proper screw configuration, time, temperature, and sheer pressure.

19. The process of claim 21, wherein said extruder pushes the polymer mixture through the length of the screw element and produces a homogenous new polymer material.

20. The process of claim 1, wherein said step of making a product is comprised of subjecting the homogenous polymer mixture to blow molding, extrusion, thermoforming, profiles, or injection molding.
